(19) United States
(12) Patent Application Publication
(10) Pub. No.: US 2023/0064634 A1
(43) Pub. Date: Mar. 2, 2023

(54) ABNORMALITY NOTIFICATION SYSTEM

(71) Applicant: TOYOTA JIDOSHA KABUSHIKI KAISHA, Toyota-shi Aichi-ken (JP)

(72) Inventors: Marie Ishikawa, Nagoya-shi Aichi-ken (JP); Aya Hamajima, Nagoya-shi Aichi-ken (JP); Daichi Hotta, Minato-ku Tokyo (JP); Hayato Ito, Susono-shi Shizuoka-ken (JP); Hidekazu Sasaki, Yokohama-shi Kanagawa-ken (JP); Yasuhiro Kobatake, Nagoya-shi Aichi-ken (JP); Akihiro Kusumoto, Susono-shi Shizuoka-ken (JP); Yoshiki Ueda, Susono-shi Shizuoka-ken (JP); Taizo Masuda, Yokohama-shi Kanagawa-ken (JP); Yuta Kataoka, Susono-shi Shizuoka-ken (JP); Hiromitsu Kobayashi, Nisshin-shi Aichi-ken (JP); Miki Nomoto, Nisshin-shi Aichi-ken (JP); Satoshi Omi, Ebina-shi Kanagawa-ken (JP); Yuki Nishikawa, Susono-shi Shizuoka-ken (JP)

(73) Assignee: TOYOTA JIDOSHA KABUSHIKI KAISHA, Toyota-shi Aichi-ken (JP)

(21) Appl. No.: 17/899,103

(22) Filed: Aug. 30, 2022

(30) Foreign Application Priority Data
Sep. 2, 2021 (JP) 2021-143308

(51) Int. Cl. G08G 1/01; G06V 20/58; G06V 10/62

(52) U.S. Cl. CPC G08G 1/0112; G08G 1/0129; G06V 20/584; G06V 10/62

(57) ABSTRACT

An abnormality notification system includes: a vehicle that travels regularly on a predetermined travel route; a communication device configured to be able to communicate with a sensor mounted on the vehicle and an outside, the sensor being a sensor that acquires road data obtained by imaging or measuring a road along the travel route; and a control device. The control device is configured to determine whether an abnormality has occurred on the road along the travel route based on a different part when the road data acquired by the sensor is compared with reference road data obtained by imaging or measuring the road along the travel route in the past, and transmit predetermined abnormality occurrence information to an external client via the communication device when the control device determines that an abnormality has occurred on the road along the travel route.

### CROSS-REFERENCE TO RELATED APPLICATION

This application claims priority to Japanese Patent Application No. 2021-143308 filed on Sep. 2, 2021, incorporated herein by reference in its entirety.

### BACKGROUND

### 1. Technical Field

The present disclosure relates to an abnormality notification system.

### 2. Description of Related Art

Japanese Unexamined Patent Application Publication No. 2020-61079 (JP 2020-61079 A) discloses a traffic violation vehicle identification system including a vehicle configured to, when a traffic violation vehicle is detected based on an image of an in-vehicle camera, transmit an evidence image of the traffic violation and characteristic information (color, vehicle type, etc.) of the traffic violation vehicle to a server, and the server configured to identify the traffic violation vehicle based on the characteristic information of the traffic violation vehicle and transmit the identification information (such as the number) of the identified traffic violation vehicle and the evidence image of the traffic violation to a client (such as the police).

### SUMMARY

Whether a vehicle has committed a traffic violation can be determined by a single image that captures the traffic violation. However, for example, when some object is placed on the road, it is difficult to determine from a single image whether it is an object temporarily placed on the road (for example, a cargo of a truck or the like during cargo handling operation) or it is an object that has been illegally dumped and left. As described above, among the abnormalities that can occur on the road, there are cases where the abnormality determination cannot be made only with the information of a single image data at a certain time point.

The present disclosure has been made by paying attention to such a problem, and an object of the present disclosure is to detect the occurrence of an abnormality for which it is difficult to make the abnormality determination only with the information of a single image data at a certain time point, among the abnormalities that can occur on the road.

In order to solve the above problem, an abnormality notification system according to an aspect of the present disclosure includes: a vehicle that travels regularly on a predetermined travel route; a communication device configured to be able to communicate with a sensor mounted on the vehicle and an outside, the sensor being a sensor that acquires road data obtained by imaging or measuring a road along the travel route; and a control device. The control device is configured to determine whether an abnormality has occurred on the road along the travel route based on a different part when the road data acquired by the sensor is compared with reference road data obtained by imaging or measuring the road along the travel route in the past, and transmit predetermined abnormality occurrence information to an external client via the communication device when the control device determines that an abnormality has occurred on the road along the travel route.

According to this aspect of the present disclosure, the road data along the travel route acquired by the vehicle that travels regularly on the predetermined travel route can be used to determine whether an abnormality has occurred on the road along the travel route by capturing the change over time on the road along the travel route. Therefore, it is possible to detect the occurrence of an abnormality for which it is difficult to make the abnormality determination only with the information of a single image data at a certain time point, among the abnormalities that can occur on the road.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of an abnormality notification system according to an embodiment of the present disclosure;

FIG. 2 is a diagram showing a hardware configuration of a vehicle; and

FIG. 3 is a flowchart illustrating an abnormality notification process according to the embodiment of the present disclosure.

### DETAILED DESCRIPTION OF EMBODIMENTS

Hereinafter, an embodiment of the present disclosure will be described below with reference to the drawings. In the following description, similar components are given the same reference numbers.

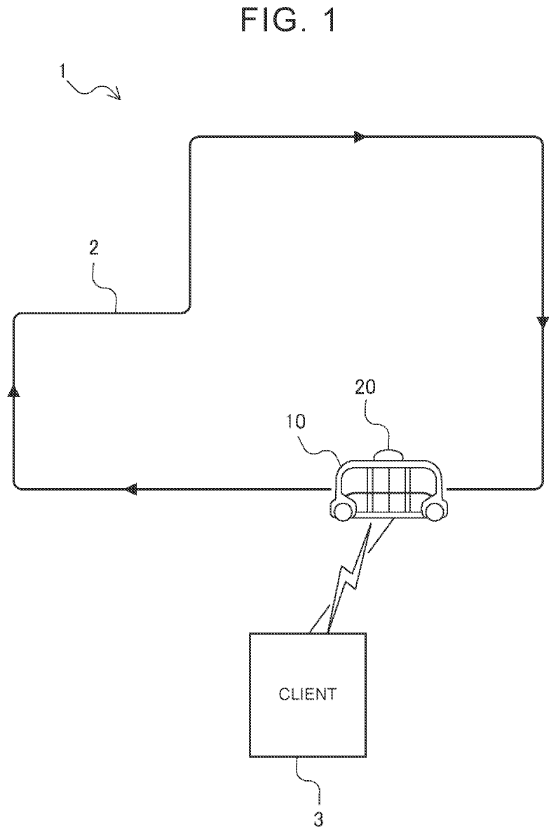

FIG. 1 is a diagram illustrating an outline of an abnormality notification system 1 according to the embodiment of the present disclosure.

As shown in FIG. 1, the abnormality notification system 1 according to the present embodiment includes a vehicle 10 that travels regularly on a predetermined travel route 2. As an example of such a vehicle 10, a bus can be mentioned, for example.

A camera 20 is mounted on the vehicle 10, and the vehicle 10 is configured to compare a current road view image (an image including a vehicle road, a pedestrian road, equipment or a building on the road) along the travel route captured by the camera 20 while traveling with the road view image captured in the past at the same location (hereinafter referred to as “reference image”), to determine whether an abnormality has occurred on the road along the travel route based on the amount of change (different part) from the reference image. The vehicle 10 is also configured to, when an abnormality has occurred on the road along the travel route, notify an external client 3 such as the police or the local government that the abnormality has occurred on the road.

The “abnormality” in the present embodiment includes, for example, a case where an illegally dumped object or a fallen object is left on a vehicle road or a pedestrian road, a case where equipment on the road (such as a sign) is stolen and missing, a case where the equipment on the road is damaged, a case where graffiti is applied to equipment on the road, a case where the light bulbs of lights such as traffic lights, street lights, and lights in the tunnel are burnt out, a case where the road has deteriorated to the extent that the road surface needs to be repaired such as a sagging road, and a case where traffic lights and signs are hidden by street trees. All of the above can be detected, or some of the above can be detected.

The reference image is a past road view image along the travel route which is captured when such an abnormality does not exist on the road along the travel route, and is stored in advance in a storage unit 42 of a control device 40 described later in the present embodiment.

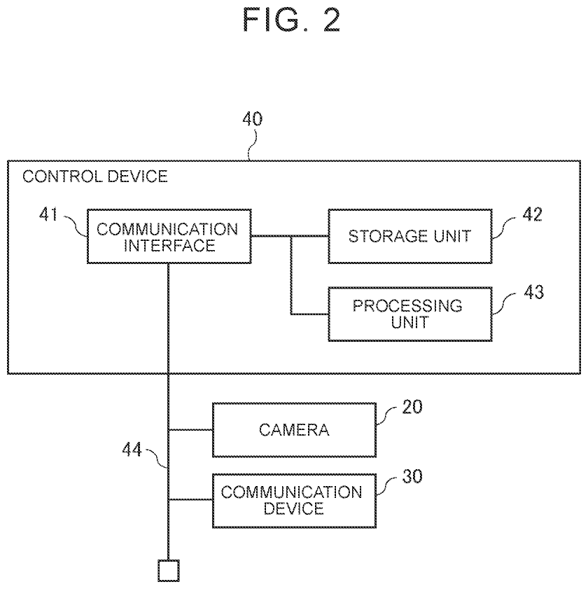

FIG. 2 is a diagram showing a hardware configuration of the vehicle 10.

As shown in FIG. 2, the vehicle 10 includes the camera 20, a communication device 30, and the control device 40. The camera 20, the communication device 30, and the control device 40 are connected to each other via an in-vehicle network 44 that conforms to a standard such as controller area network (CAN).

The camera 20 is, for example, an omnidirectional camera mounted on the roof of the vehicle 10. The camera 20 periodically captures images of the road view along the travel route while the vehicle 10 is traveling, and transmits the captured road view images to the control device 40 in association with the information on the location where the road view images were acquired (for example, the latitude and the longitude of the vehicle 10) and the time when the road view images were acquired (in other words, information on the imaging location and the imaging time of the road view images). The type, the number, and the mounting position of the cameras 20 are not particularly limited as long as they are configured to capture the road view along the travel route.

The communication device 30 is an in-vehicle terminal having a wireless communication function. In the present embodiment, the communication device 30 communicates with the external client 3 (such as the police, the local government, etc.) when an abnormality is detected on the road along the travel route, and provides the client 3 with abnormality occurrence information.

The control device 40 includes a communication interface 41, the storage unit 42, and a processing unit 43. The communication interface 41, the storage unit 42, and the processing unit 43 are connected to each other via signal lines.

The communication interface 41 is a communication interface circuit for connecting the control device 40 to the in-vehicle network 44.

The storage unit 42 has a storage medium such as a hard disk drive (HDD), an optical recording medium, and a semiconductor memory, and stores various computer programs, data, and the like used for processing in the processing unit 43.

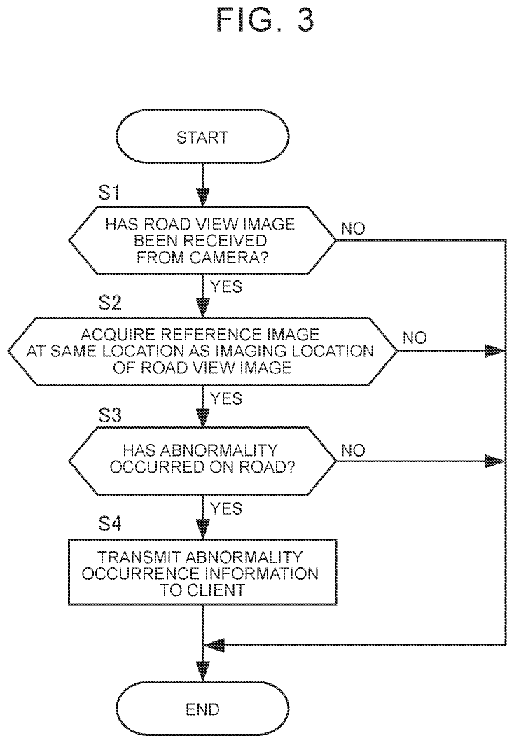

The processing unit 43 has one or a plurality of central processing units (CPUs) and peripheral circuits thereof. The processing unit 43 executes various computer programs stored in the storage unit 42 to perform various processes, and is, for example, a processor. Hereinafter, an abnormality notification process according to the present embodiment, which is one of the processes performed by the processing unit 43, that is, the control device 40, will be described with reference to FIG. 3.

FIG. 3 is a flowchart illustrating the abnormality notification process performed by the control device 40.

In step S1, the control device 40 determines whether the current road view image along the travel route captured by the camera 20 has been received from the camera 20. When the control device 40 has received the road view image from the camera 20, the control device 40 proceeds to the process of step S2. On the other hand, when the control device 40 has not received the road view image from the camera 20, the control device 40 ends the current process.

In step S2, the control device 40 acquires the reference image acquired at the same location as the location where the road view image received in step S1 is acquired, from the reference images stored in advance in the storage unit 42.

In step S3, the control device 40 compares the road view image received in step S1 with the reference image acquired in step S2 and analyzes a different part from the reference image, to determine whether an abnormality has occurred on the road along the travel route, such as whether an illegally dumped object or a fallen object is left on the road as described above, for example. When an abnormality has occurred on the road along the travel route, the control device 40 proceeds to the process of step S4. On the other hand, the control device 40 ends the current process when no abnormality has occurred on the road along the travel route.

In step S4, the control device 40 notifies the client 3 of the abnormality occurrence information via the communication device 30. The abnormality occurrence information is information for notifying the client 3 that an abnormality has occurred on the road along the travel route, and can include a road view image and an abnormality occurrence location (that is, a location where the road view image is acquired). This enables the client 3 to promptly take appropriate measures against the abnormality that has occurred on the road along the travel route. The abnormality occurrence information can also include a time zone in which the abnormality is considered to have occurred on the road along the travel route (that is, a time zone from the time when the vehicle 10 traveled along the abnormality occurrence location last time to the time when the vehicle 10 traveled along the abnormality occurrence location this time). This enables the client 3 to easily grasp the time zone in which the abnormality has occurred on the road along the travel route.

The abnormality notification system 1 according to the present embodiment described above includes the vehicle 10 that travels regularly on the predetermined travel route 2, the communication device 30 configured to be able to communicate with the camera 20 (sensor) and the outside, and the control device 40. The camera 20 is mounted on the vehicle 10 and acquires a road view image (road data) captured on the road along the travel route. The control device 40 is configured to determine whether an abnormality has occurred on the road along the travel route based on a different part when the road view image acquired by the camera 20 is compared with the reference image (reference road data) captured or measured in the past on the road along the travel route. The control device 40 is also configured to transmit the predetermined abnormality occurrence information to the external client 3 via the communication device 30 when the control device 40 determines that an abnormality has occurred on the road along the travel route.

As a result, with the abnormality determination system according to the present embodiment, the road view image along the travel route acquired by the camera 20 mounted on the vehicle 10 that travels regularly on the predetermined travel route 2 can be used to determine whether an abnormality has occurred on the road along the travel route by capturing the change over time on the road along the travel route. Therefore, it is possible to detect the occurrence of an abnormality for which it is difficult to make the abnormality determination only with the information of a single image data at a certain time point, among the abnormalities that can occur on the road, and transmit information on the abnormality to the client 3.

The abnormality occurrence information can include the estimated time zone in which the abnormality occurred on the road along the travel route, that is, information on the time zone from the time when the vehicle 10 traveled last time to the time when the vehicle 10 traveled this time at the location where the road view image (road data) used for abnormality determination was acquired. Further, the abnormality occurrence information can include information on the road view image used for the abnormality determination and information on the location where the road view image (road data) is acquired. This makes it possible to promote subsequent investigation to arrest the criminal and repair of the abnormal part by the client 3.

Although the embodiment of the present disclosure has been described above, the above embodiment shows only a part of the application examples of the present disclosure, and the technical scope of the present disclosure is not limited to the specific configuration of the above embodiment.

For example, in the above embodiment, the control device 40 is mounted on the vehicle 10, but the control device 40 may be replaced with an external server. In this case, the road view image may be transmitted to the server serving as the control device 40, the server may make an abnormality determination using the road view image, and the server may transmit the abnormality occurrence information to the client 3 in accordance with the determination result.

Further, in the above embodiment, the reference image is stored in advance in the storage unit 42 of the control device 40, but the present disclosure is not limited to this, and for example, communication may be performed with an external server via the communication device 30 to appropriately receive the latest reference image from the server. Alternatively, the road view image acquired in the past by the own vehicle 10 may be set as the reference image.

Further, in the above embodiment, the abnormality determination is made based on the road view image captured by the camera 20, but the present disclosure is not limited to this, and the abnormality determination may be made by comparing road measurement data (road data) along the travel route measured by, for example, light detection and ranging (LiDAR) with reference road measurement data.

The abnormality notification system of the present disclosure is also applicable to autonomous driving vehicles.

What is claimed is:

1. An abnormality notification system comprising:
a vehicle that travels regularly on a predetermined travel route;
a communication device configured to be able to communicate with a sensor mounted on the vehicle and an outside, the sensor being a sensor that acquires road data obtained by imaging or measuring a road along the travel route; and
a control device, wherein the control device is configured to
determine whether an abnormality has occurred on the road along the travel route based on a different part when the road data acquired by the sensor is compared with reference road data obtained by imaging or measuring the road along the travel route in the past, and
transmit predetermined abnormality occurrence information to an external client via the communication device when the control device determines that an abnormality has occurred on the road along the travel route.

2. The abnormality notification system according to claim 1, wherein
the abnormality occurrence information includes information on an estimated time zone in which an abnormality has occurred on the road along the travel route, and
the estimated time zone is a time zone from a time when the vehicle traveled last time to a time when the vehicle traveled this time at a location where the road data used for abnormality determination was acquired.

3. The abnormality notification system according to claim 1, wherein the abnormality occurrence information includes information on the road data used for abnormality determination and information on a location where the road data is acquired.
